(19) United States
(12) Patent Application Publication
(10) Pub. No.: US 2025/0106326 A1
(43) Pub. Date: Mar. 27, 2025

(54) INFORMATION PROCESSING APPARATUS, METHOD FOR CONTROLLING INFORMATION PROCESSING APPARATUS, INSPECTOR, AND METHOD FOR CONTROLLING INSPECTOR

(71) Applicant: CANON KABUSHIKI KAISHA, Tokyo (JP)

(72) Inventor: SATOSHI YOSHIDA, Kanagawa (JP)

(21) Appl. No.: 18/890,039

(22) Filed: Sep. 19, 2024

(30) Foreign Application Priority Data
Sep. 25, 2023 (JP) 2023-160114

(51) Int. Cl. H04N 1/00; G06T 7/00

(52) U.S. Cl. CPC H04N 1/00087; G06T 7/001; H04N 1/00037; H04N 1/00045; G06T 2207/30144

(57) ABSTRACT

An information processing apparatus is connectable to at least a printer and an inspector that performs inspection of a printed material printed with the printer. The information processing apparatus includes: a reception unit that receives a job setting for received print data; a generation unit that generates image data in which pixel information is added to the print data; and a transmitter unit that transmits the image data. In response to the reception unit receiving a predetermined job setting, the generation unit assigns pixel information indicating exclusion from the inspection by the inspector to a pixel in an image area provided in the job setting.

### BACKGROUND

### Field of the Disclosure

The present disclosure relates to an information processing apparatus, a method for controlling the information processing apparatus, an inspector, and a method for controlling the inspector.

### Description of the Related Art

Inspectors that read a printed material printed by a printer and that inspect the quality thereof are known. Each inspector is capable of detecting image defects such as dirt and printing omission, a text error, a bar code quality, and the like. For these image defects and the print quality inferiority, it is typically possible to detect a defect type and to set a threshold for the image defect detection on a per detected type basis.

In the inspection for these items, a method by which a printed material is compared with an image that does not have a defect and that has been registered as a reference image is used. Hence, a reference image is required to be registered in the inspector, and processing for the registration is referred to as a reference image registration job. A user then performs an inspection setting operation. In the inspection setting operation, an area and a threshold for detecting a defect in an actual print job are set for the reference image. An area excluded from inspection can serve as one type of the threshold. For example, an image provided by the printer (such as patches for adjustment) and a cutting area are set as the inspection exclusion. After the end of the inspection settings, an actual print job for detecting a defect by comparing an actual printed material with the registered reference image is executed.

Japanese Patent Laid-Open No. 2023-48244 describes a technique by which an area to be excluded from inspection (an inspection exclusion area) is automatically set in a printer in such a manner that positional information regarding an image provided by the printer is stored and reported to an inspector.

### SUMMARY

Embodiments of the present disclosure provide an information processing apparatus connectable to at least a printer and an inspector that performs inspection of a printed material printed with the printer. The information processing apparatus includes: a reception unit that receives a job setting for received print data; a generation unit that generates image data in which pixel information is added to the print data; and a transmitter unit that transmits the image data. In response to the reception unit receiving a predetermined job setting, the generation unit assigns pixel information indicating exclusion from the inspection by the inspector to a pixel in an image area provided in the job setting.

Further features of the present disclosure will become apparent from the following description of exemplary embodiments with reference to the attached drawings.

### BRIEF DESCRIPTION OF THE DRAWINGS

FIG. 1 is a schematic diagram illustrating the configuration of an information processing apparatus, an inspector, and a printer.

FIGS. 2A and 2B are block diagrams illustrating the configuration of the information processing apparatus, the inspector, and the printer.

FIG. 3 is a view illustrating the inner configuration of the information processing apparatus, the inspection unit, the printer, and a large capacity stacker.

FIGS. 4A to 4C are setting screens of the inspector from which an operation mode of the inspector and the inspection unit is designated.

FIG. 5 illustrates an inspection state screen displayed on the inspector at the time of inspection.

FIG. 6 is a flowchart of reference image registration in the inspector.

FIGS. 7A and 7B are flowcharts of an inspection with the inspector.

FIG. 8 is a flowchart of attribute flag determination by the information processing apparatus in a first embodiment.

FIGS. 9A to 9C each illustrate a print result image.

FIGS. 10A to 10G are views illustrating a reference image and attribute flags.

FIGS. 11A and 11B illustrate inspection setting screens.

FIGS. 12A and 12B are a job setting table and coordinate mapping based on the job setting table in a first embodiment.

FIG. 13 is a flowchart of inspection area settings in the inspector.

FIG. 14 is an inspection setting table.

FIGS. 15A and 15B are tables of correspondence between an attribute flag type and an 8-bit numeric value.

FIGS. 16A and 16B are flowcharts of attribute flag determination by an information processing apparatus in a second embodiment.

FIG. 17 is a flowchart of attribute flag determination by an information processing apparatus in a third embodiment.

FIG. 18 is a flowchart of attribute flag determination by a printer in a fourth embodiment. FIGS. 19A and 19B are job setting tables in a fourth embodiment.

### DESCRIPTION OF THE EMBODIMENTS

### First Embodiment

Hereinafter, embodiments of the present disclosure will be described by using the drawings. The present disclosure is applicable to any inspector configured from a single apparatus or a plurality of apparatuses as long as functions according to the present disclosure are implemented unless otherwise particularly stated. The present disclosure is also applicable to an inspector that is connected via a network such as a local area network (LAN) or a wide area network (WAN) that performs processing as long as the functions of the present disclosure are implemented. System configurations allowing connection of various terminals described in the following embodiments are thus examples, and the present disclosure is applicable to various configuration examples depending on the usage or the purpose.

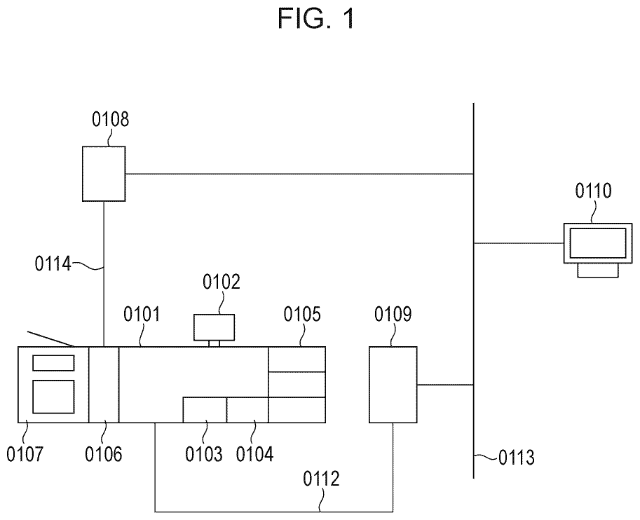

FIG. 1 is a schematic diagram illustrating an inspection system in this embodiment, that is, the configuration of an information processing apparatus, an inspector, and a printer. The printer of this embodiment is described by using a printer using an electrophotographic method but may be a printer using a different image forming method such as an ink-jet method or an offset method.

A printer 0101 is connected to an information processing apparatus 0109 via a cable 0112. The information processing apparatus 0109 is connected to a client computer 0110 via a network 0113 to be able to communicate with the client computer 0110.

The printer 0101 includes a user interface (UI) panel 0102, a paper feed deck 0103, and a paper feed deck 0104. An optional deck 0105 composed of three stacked paper feed decks is further connected to the printer 0101. The printer 0101 is, for example, an electrophotograpic printer. The UI panel 0102 is a user interface including, for example, a capacitive touch panel.

The printer 0101 further includes an inspection unit 0106 and a large capacity stacker 0107. The inspection unit 0106 is connected to an inspector 0108 via a cable 0114. The large capacity stacker 0107 includes a main tray and a top tray, and thousands of sheets can be stacked in the main tray at one time.

A print job is generated by the client computer 0110, transmitted to the information processing apparatus 0109 via the network 0113, and managed by the information processing apparatus 0109. The print job is transmitted from the information processing apparatus 0109 to the printer 0101 via the cable 0112, and the printer 0101 performs processing for printing on a sheet. The print job may be generated and managed by the information processing apparatus 0109, transmitted to the printer 0101 via the network 0113, and managed by the printer 0101.

The client computer 0110, the information processing apparatus 0109, and the inspector 0108 may be connected to the cable 0112 to be able to communicate with the printer 0101. The inspector 0108 may also be connected to the information processing apparatus 0109 and the client computer 0110 via the network 0113. That is, the connection form of the printer 0101, the information processing apparatus 0109, and the client computer 0110 described in this embodiment is an example, and it goes without saying that there various connection forms other than the connection form described in this embodiment.

Not only the inspection unit 0106 and the large capacity stacker 0107 but also a finisher capable of stapling, a folding machine, a book-binder, and other devices may also be connected to the printer 0101.

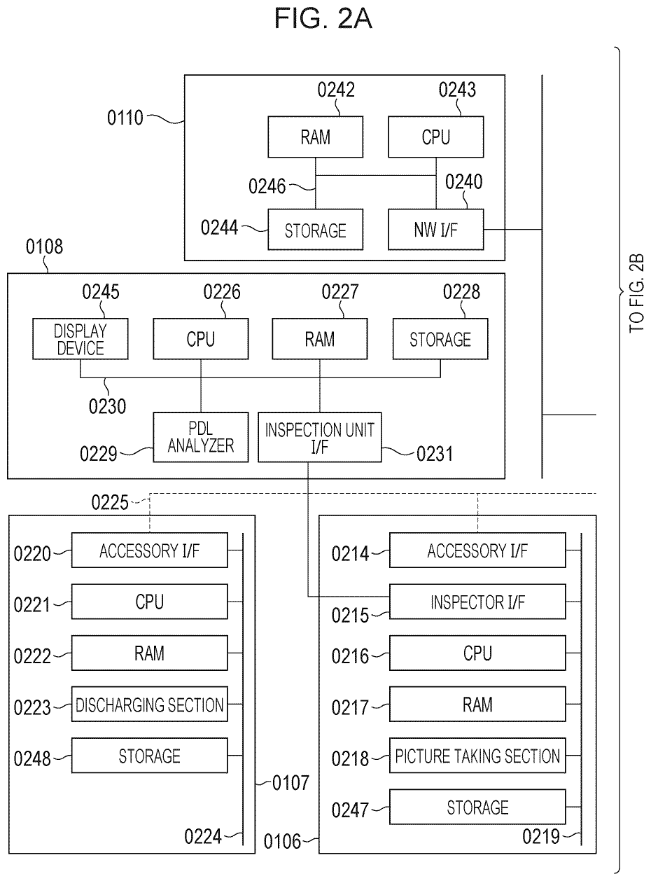

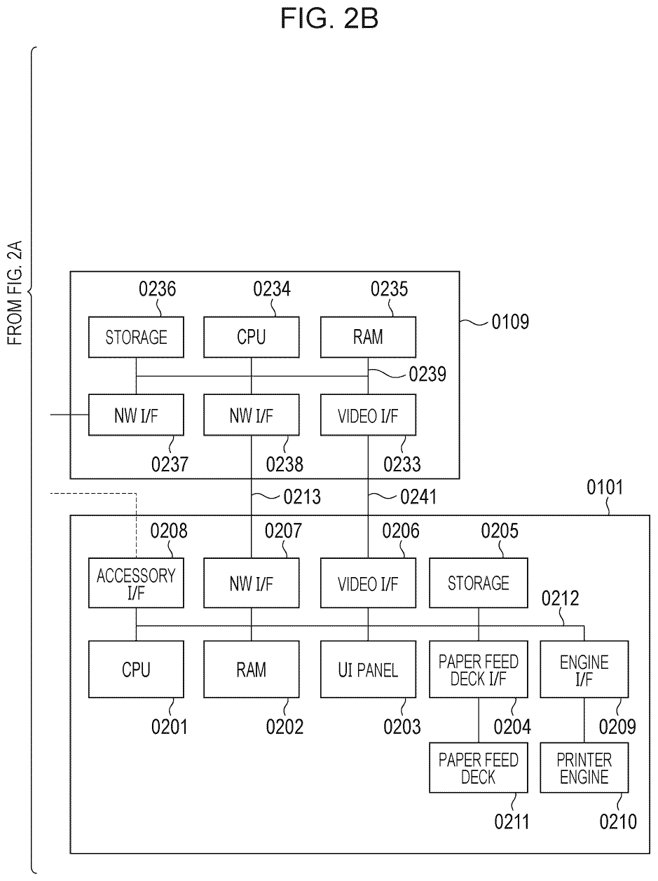

FIGS. 2A and 2B are block diagrams illustrating the configuration for controlling the printer 0101, the inspector 0108, the large capacity stacker 0107, the information processing apparatus 0109, and the client computer 0110 of this embodiment.

A central processing unit (CPU) 0201 is in charge of control and computing inside the printer 0101 through a system bus 0212. The CPU 0201 is in charge of running a program stored in a storage 0205 and then loaded into a random access memory (RAM) 0202. The RAM 0202 is a type of general volatile memory directly accessible from the CPU 0201 and is used as a work area or another temporary data storage area for the CPU 0201. The storage 0205 functions as a temporarily storage area and a work memory while the printer 0101 is operating.

An engine I/F 0209 is in charge of communication with and control of a printer engine 0210. A paper feed deck I/F 0204 is in charge of communication with and control of a paper feed deck 0211. The paper feed decks 0103 and 0104 and the optional deck 0105 are collectively referred as the paper feed deck 0211 as hardware components. A UI panel 0203 is a hardware component of the UI panel 0102 and is a user interface for performing overall operation of the printer 0101. In this embodiment, the UI panel 0203 includes a capacitive touch panel.

A network interface (hereinafter, NW I/F) 0207 is connected to a NW I/F 0238 of the information processing apparatus 0109 via a cable 0213 and is in charge of communication with the information processing apparatus 0109 and the printer 0101. In this example, the interfaces respectively connected to the system bus 0212 and a system bus 0239 are directly connected; however, the information processing apparatus 0109 and the printer 0101 may be connected, for example, via a network, and the connection form is not limited. A video I/F 0206 is connected to a video I/F 0233 via a video cable 0241 and is in charge of image data communication between the information processing apparatus 0109 and the printer 0101.

The functions of the NW I/F 0238 and the video I/F 0233 may be integrated as the connection interface, in the information processing apparatus 0109, with the printer 0101. The functions of the NW I/F 0207 and the video I/F 0206 may also be integrated as the connection interface, in the printer 0101, with the information processing apparatus 0109.

An accessory I/F 0208 is connected to an accessory I/F 0214 and an accessory I/F 0220 via a cable 0225. The printer 0101 thus mutually communicates with the inspection unit 0106 and the large capacity stacker 0107 via the accessory I/Fs 0208, 0214, and 0220.

A CPU 0216 is in charge of control and computing through a system bus 0219 inside the inspection unit 0106 and running a program stored in a storage 0247 and then loaded into a RAM 0217. The RAM 0217 is a type of general volatile memory directly accessible from the CPU 0216 and is used as a work area or another temporary data storage area for the CPU 0216. The storage 0247 functions as a temporarily storage area and a work memory while the inspector 0108 is operating. An inspector I/F 0215 is connected to the inspection unit I/F 0231 via the cable 0248. that is, the inspection unit 0106 thus performs communication with the inspector 0108 via the inspector I/F 0215 and an inspection unit I/F 0231.

An image taking section 0218 has a image taking function with, for example, a contact image sensor (hereinafter, a CIS), takes an image of a sheet passing through the inspection unit 0106, and transmits the taken image to the inspector 0108 via the inspector I/F 0215. The CIS for the image taking section 0218 is an example of a sensor and may be another type of sensor such as a CCD image sensor. The image taking method therefor is not limited. The taken image is transmitted for two purposes. One of the purposes is inspection. An image of a printed material serving as an inspection target print job is taken by any inspection method and is transmitted to the inspector 0108 for the inspection. The other is generating a reference image. If the inspection method is scan inspection, printing and image taking are performed on one or more sheets in an inspection target print job before the print job to generate one or more reference image, and each image is transmitted as the reference image to the inspector 0108. The inspector 0108 stores the transmitted image as the reference image in a storage 0228.

The CPU 0221 is in charge of control and computing through a system bus 0224 inside the large capacity stacker 0107 and running a program stored in a storage 0248 and then loaded into a RAM 0222. The RAM 0222 is a type of general volatile memory directly accessible from the CPU 0221 and is used as a work area or another temporary data storage area for the CPU 0221. The storage 0248 functions as a temporarily storage area and a work memory while the inspector 0108 is operating. A discharging section 0223 is in charge of operations of discharging to the main tray and the top tray and monitoring and control of stacking states of the main tray and the top tray.

The inspector 0108 is described. A CPU 0226 is in charge of control and computing through a system bus 0230 inside the inspector 0108 and running a program stored in the storage 0228 and then loaded into a RAM 0227. The RAM 0227 is a type of general volatile memory directly accessible from the CPU 0226 and is used as a work area or another temporary data storage area for the CPU 0226. The storage 0228 functions as a temporarily storage area and a work memory while the inspector 0108 is operating. A page description language (PDL) analyzer 0229 reads PDL data such as PDF, PostScRIPt, or PCL data, received from the client computer 0110 or the information processing apparatus 0109 and executes an interpretation process. A display device 0245 is, for example, a liquid crystal display connected to the inspector 0108. The display device 0245 receives input by the user to the inspector 0108 and displays the state of the inspector 0108.

The information processing apparatus 0109 is described. A CPU 0234 is in charge of control and computing through the system bus 0239 inside the information processing apparatus 0109 and running a program stored in a storage 0236 and then loaded into a RAM 0235. The RAM 0235 is a type of general volatile memory directly accessible from the CPU 0234 and is used as a work area or another temporary data storage area for the CPU 0234. The storage 0236 functions as a temporarily storage area and a work memory while the information processing apparatus 109 is operating. A network interface 0237 is connected to a NW I/F 0240 via a network. The information processing apparatus 0109 communicates with the client computer 0110 via the NW I/F 0237 and the NW I/F 0240.

The inspector 0108 may have a NW I/F, and the information processing apparatus 0109 may communicate with the inspector 0108 via the NW I/F and the NW I/F 0237. For example, assume a case where raster image processor (RIP) inspection is used as the inspection method, and a RIP image used for printing by the printer 0101 is used as the reference image. In this case, the reference image may be transmitted to the inspector 0108 via the inspector I/F 0215 or may be transmitted to the inspector 0108 via the NW I/F 0207, the NW I/F 0237, and the NW I/F of the inspector 0108.

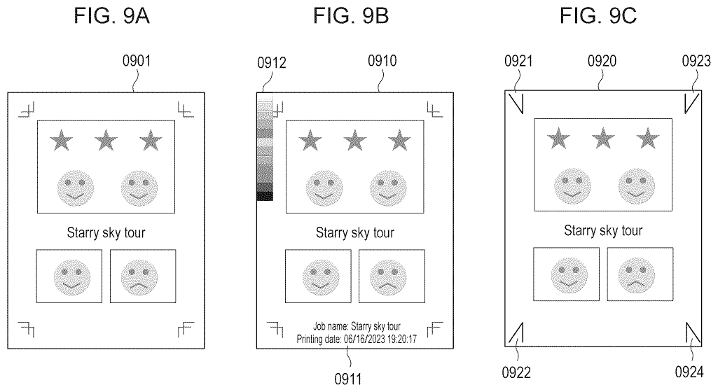

The information processing apparatus 0109 has a control bar function as a function related to print jobs. FIGS. 9A to 9C illustrate print result images. FIG. 9A illustrates a print result image 0901 at the time when the control bar function is off. FIG. 9B illustrates a print result image 0910 when the control bar function is on. When the control bar function is on, the CPU 0234 provides print data with job information 0911 indicating a job name and printing date and time and a color bar 0912 for tint verification at predefined positions.

The client computer 0110 is described. A CPU 0243 is in charge of control and computing through a system bus 0246 inside the client computer 0110 and running a program stored in the storage 0244 and then loaded into a RAM 0242. The RAM 0242 is a type of general volatile memory directly accessible from the CPU 0243 and is used as a work area or another temporary data storage area for the CPU 0243. A storage 0244 functions as a temporarily storage area and a work memory while the client computer 0110 is operating.

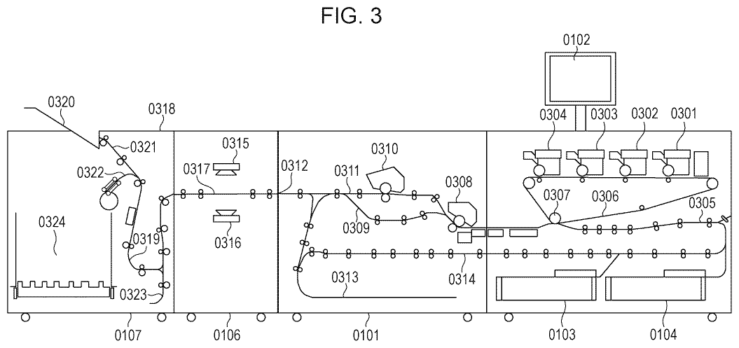

FIG. 3 is a view illustrating the inner configuration of the printer 0101, the inspection unit 0106, and the large capacity stacker 0107. The printer 0101 receives input by the user via the UI panel 0102 and displays printing and apparatus states. The paper feed decks 0103 and 0104 are capable of accommodating various sheet. Only a topmost sheet of the loaded sheets can be separated from each paper feed deck and transported to a sheet transportation path 0305. Reference numerals 0301 to 0304 denote development stations which form toner images by using Y, M, C, and K color toners to form color images. The formed toner images at this stage undergo primary transfer onto an intermediate transfer belt 0306. The intermediate transfer belt 0306 rotates clockwise in FIG. 3, and the toner images are transferred, at the secondary transfer position 0307, onto a sheet transported from the sheet transportation path 0305. A fixing unit 0308 includes a pressure roller and a heat roller. The sheet passes between the rollers, the toners are fused and pressed against the sheet, and thereby the toner images are fixed on the sheet. The sheet having exited from the fixing unit 0308 is transported to a sheet transportation path 0312 via a sheet transportation path 0309. If further fusing and pressing is required for the fixing due to the sheet type, the sheet is transported to a second fixing unit 0310 via the fixing unit 0308 and an upper sheet transportation path, undergoes additional fusing and pressing, and is transported to the sheet transportation path 0312 via a sheet transportation path 0311. If the image forming mode is duplex, the sheet is transported to a sheet reversing path 0313, reversed due to the reversing path 0313, and is transported to a duplex transportation path 0314, and a second surface of the sheet undergoes image transfer at a secondary transfer position 0307.

CISs 0315 and 0316 are disposed in the inspection unit 0106 in such a manner as to face each other. The CIS 0315 is a sensor for reading the upper surface of the sheet, and the CIS 0316 is a sensor for reading the lower surface of the sheet. By using the CISs 0315 and 0316, the inspection unit 0106 scans the sheet transported to a sheet transportation path 0317 at timing when the sheet reaches the predetermined position. The scanned image is transmitted to the inspector 0108 via the inspector I/F 0215 and the inspection unit I/F 0231. The CPU 0226 determines whether the received image has a defect the determined result and reports the determination result to the inspection unit 0106 via the inspection unit I/F 0231 and the inspector I/F 0215 again. The CPU 0216 reports the received determination result to the large capacity stacker 0107 via the accessory I/Fs 0214 and 0220.

Reference numeral 0107 denotes the large capacity stacker in which a large volume of sheets can be stacked. The large capacity stacker 0107 has a main tray 0324 serving as a tray where the sheets are stacked. A sheet having passed through the inspection unit 0106 enters the large capacity stacker 0107 via a sheet transportation path 0319. The sheet passes the sheet transportation path 0319 and a sheet transportation path 0322 and is then stacked in the main tray 0324. The large capacity stacker 0107 further has a top tray 0320 as a discharge tray. The CPU 0221 discharges, to the top tray 0320, a sheet a defect of which is detected by the inspector 0108. To output the sheet to the top tray 0320, the sheet is transported from the sheet transportation path 0319 to the top tray 0320 via a sheet transportation path 0321. Reference numeral 0323 denotes a reversing section for reversing a sheet. The reversing section 0323 is used to stack the sheet in the main tray 0324. In the case where the sheet is stacked in the main tray 0324, the sheet is once reversed in the reversing section 0323 to match the orientation of an entering sheet and the orientation of a stacked sheet. In the case where the sheet is transported to the top tray 0320, the reversing operation is not performed in the reversing section 0323 because the sheet is discharged without being flipped.

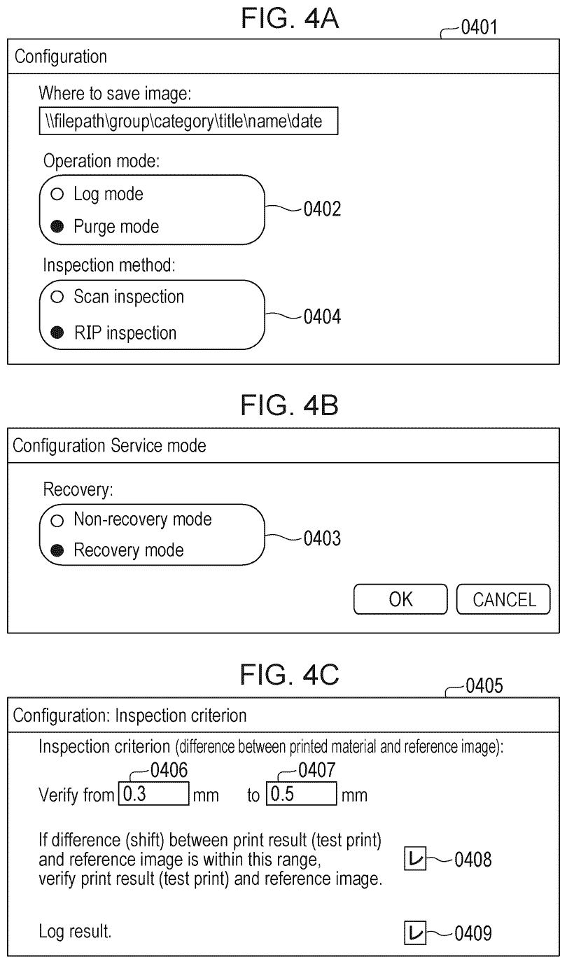

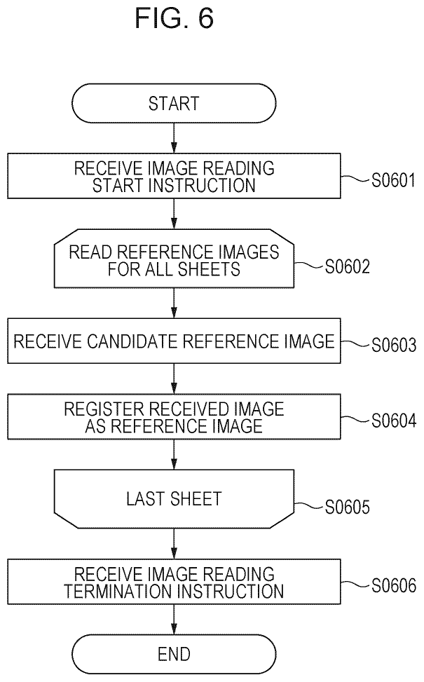

FIG. 4A illustrates a setting screen of the inspector 0108 for an operation mode. An operation mode setting screen 0401 is displayed on the display device 0245 to receive an operation mode setting from the user. If Log mode is selected in an operation mode selection field 0402, the printer 0101 discharges a sheet subjected to the inspection to a sheet discharging destination designated in advance as a print job property regardless of the result of inspection by the inspector 0108. If Purge mode is selected in the operation mode selection field 0402, the printer 0101 discharges the sheet having the inspection NG result to the top tray 0320. If Scan inspection is selected in an inspection method selection field 0404, the inspector 0108 uses the scanned image of a printed material as a reference image to be used for the inspection. If RIP inspection is selected, the inspector 0108 uses, as the reference image, a RIP image used by the printer 0101 for printing. A process for generating and storing a reference image will be described b using a flowchart in FIG. 6.

FIG. 4B illustrates a recovery setting screen of the inspector 0108 for Purge mode. If Purge mode is selected in the operation mode selection field 0402, the recovery mode setting on a recovery mode setting screen 0403 is further reflected. The recovery mode setting screen 0403 is displayed on the display device 0245 to receive a recovery mode setting from the user. If Non-recovery mode is selected on the recovery mode setting screen 0403, the printer 0101 discharges only the sheet having the inspection NG result to the top tray 0320. The printer 0101 and the inspector 0108 continue the inspection of succeeding sheets as in ordinary operation. If Recovery mode is selected on the recovery mode setting screen 0403, the printer 0101 discharges, to the top tray 0320, the sheet having the inspection NG result and all of fed succeeding sheets included in the printer 0101 at a time point when the inspector 0108 determines the sheet as having the inspection NG result. When there is no sheet thereafter on the sheet transportation paths, the printer 0101 and the inspector 0108 resume the printing and the inspection started with an image printed on the sheet having the inspection NG result. The inspector 0108 in this embodiment performs the inspection in such a manner that an image is taken with the CISs 0315 and 0316 of the inspection unit 0106 while the printer 0101 is performing printing. For this reason, when the inspector 0108 determines a sheet as having an inspection NG result, a succeeding sheet is likely to have reached the sheet transportation path 0309 or 0311. However, unless all the sheets on the sheet transportation paths, it is not possible to again print the image printed on the sheet having the inspection NG result and to stack the sheet in a correct output order in the sheet discharging destination designated in advance in the print job. Accordingly, the operations as described above are performed in the recovery mode. The CPU 0226 reports an operation mode, a recovery mode, and an inspection method that are respectively set in the operation mode selection field 0402, the recovery mode setting screen 0403, and the inspection method selection field 0404 to the inspection unit 1016 via the inspection unit I/F 0231 and the inspector I/F 0215.

The operation mode, the recovery mode, and the inspection method that are respectively set in the operation mode selection field 0402, the recovery mode setting screen 0403, and the inspection method selection field 0404 are stored by the CPU 0226 in the RAM 0227 and by the CPU 0216 in the RAM 0217 store.

FIG. 4C illustrates a setting screen of the inspector 0108 for an inspection criterion. An inspection criterion setting screen 0405 is displayed on the display device 0245 to receive an inspector inspection criterion setting from the user. The inspection criterion is an NG determination criterion for the inspection, and a distance is used to represent a difference between a print result and a reference image. In this embodiment, the difference between the print result and the reference image represents a difference between the RIP image (described later) and a printed material, the difference being derived from a positional shift and the features of a printer. The inspector 0108 determines the difference between the print result and the reference image as OK if the difference value is smaller than a higher limit reference value 0406. The higher limit reference value 0406 is shared with Scan inspection and RIP inspection. A lower limit reference value 0407 is valid when RIP inspection is selected in the inspection method selection field 0404. If RIP inspection is selected in the inspection method selection field 0404, the inspector 0108 determines whether the difference between the printing result and the reference image is within a range between the higher limit reference value 0406 and the lower limit reference value 0407. In this embodiment, for the inspection criterion, the distance is used as the difference between the print result and the reference image; however, a different parameter such as tint may be presented for the inspection criterion.

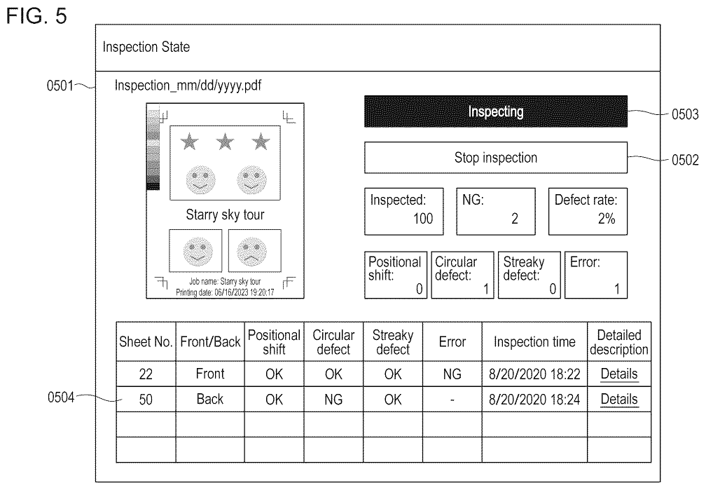

FIG. 5 illustrates an inspection state screen displayed on when the inspection is performed. An inspection state screen 0501 is displayed on the display device 0245 to receive inspection execution and stopping and display the inspection state. An inspection button 0502 is used to receive instructions to execute and stop the inspection from the user.

In response to the inspection button 0502 being pressed, text strings in the inspection button 0502 and an inspection status 0503 are respectively changed to “Stop inspection” and “Inspecting”. In response to the inspection button 0502 being pressed again, text strings in the inspection button 0502 and the inspection status 0503 are respectively changed to “Start inspection” and “Stopping”.

After this, every time the inspection button 0502 is pressed, the text strings in the inspection button 0502 and the inspection status 0503 toggle. On the inspection state screen 0501, the number of inspected sheets, the number of sheets having inspection NG results, a defect rate, and the number of occurrences of the causes of the inspection NG result are displayed in real-time during the inspection. Error is displayed on the inspection state screen 0501 when the number of events determined as an error and equivalence to an inspection NG result by the inspector 0108 based on time-out because the inspection is not terminated with a predetermined inspection period of time. Every time an inspection NG result occurs, the sheet number of a sheet having an inspection NG result, information regarding a front side or back side, a cause of the inspection NG result, an inspection time, and a link to a NG details screen (not illustrated) are added to an inspection NG list 0504. In response to Details being pressed, the display device 0245 displays a screen where a taken image resulting in inspection NG, the position of the defect, and the like can be viewed. As the cause of the inspection NG result, a positional shift, a circular defect (dot), a streaky defect (streak), and the like are exemplified. A positional shift is a defect in which the entirety or part of the image is shifted as a whole in comparison between the scanned image and the reference image. The circular defect represents a state where circular dirt is present only in the scanned image. The streaky defect represents streaky or linear dirt only in the scanned image. The inspector 0108 is capable of identifying the type of the detected defect based on the feature of the defect as described above and displaying the defect type on the inspection NG list 0504. These are examples, and the defect types detectable by the inspector 0108 are not limited to these. For example, a state where an image is drawn only in the reference image and the entirety or part of the image is not drawn in the scanned image may be determined as image omission and may be added to the inspection NG results.

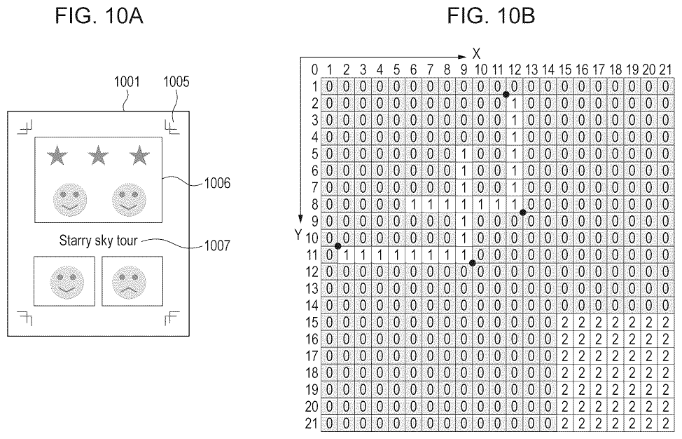

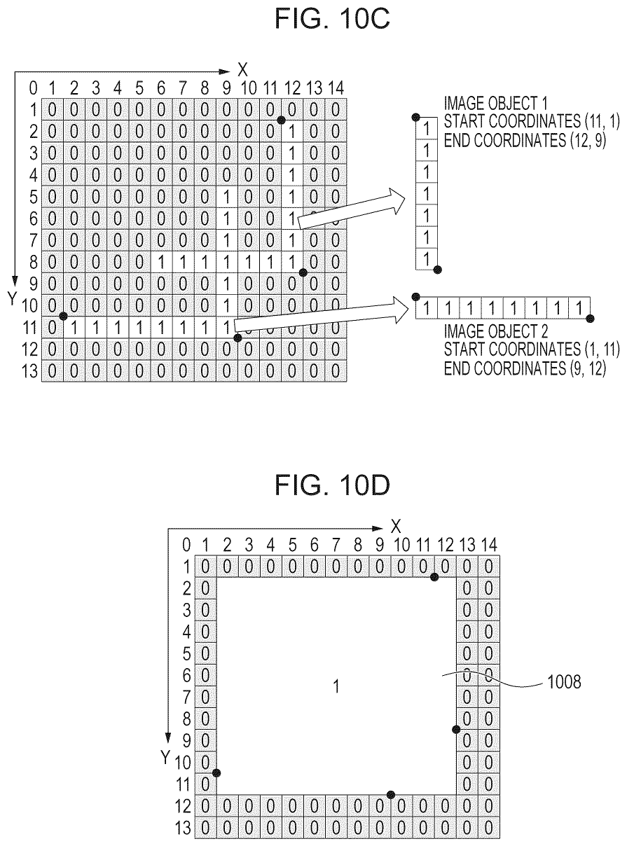

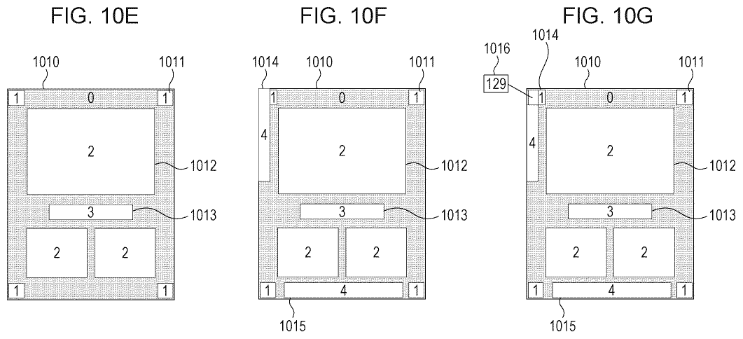

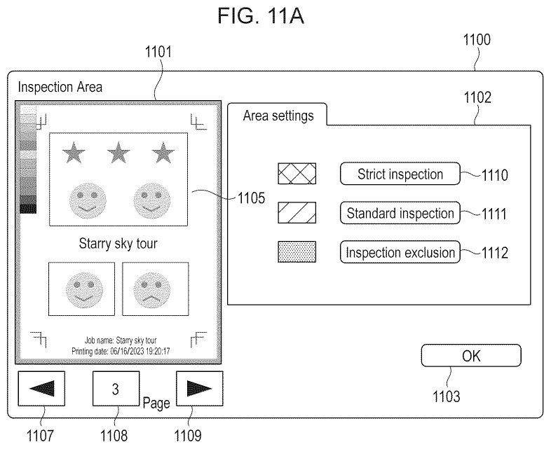

FIGS. 10A to 10G are views representing a reference image and attribute flags that are generated in this embodiment. In this embodiment, the information processing apparatus 0109 or the printer 0101 transmits a reference image and an attribute flag as data to be used in an inspection to the inspector 0108. As previously mentioned, a reference image 1001 is a scanned image acquired from a printed material if the inspection method is Scan inspection or is a RIP image used by the printer 0101 if the inspection method is RIP inspection. In the case of Scan inspection, data expressed with an 8-bit digital signal for each of pixels resulting from the scanning of the printed material with the CIS 0315 and the CIS 0316 of the inspection unit 0106 serves as the reference image. In the case of RIP inspection, the information processing apparatus 0109 and the printer 0101 receive text described in the PDL and image data from the client computer 0110. The CPU 0234 and the CPU 0201 thereafter perform RIP processing and thereby generate an RIP image (bitmap image). In the case of RIP inspection, data generated by performing the RIP processing and expressed with an 8-bit digital signal for each pixel serves as the reference image. The printer 0101 performs printing by using the RIP image. The proposal is made regarding RIP inspection as the inspection method.

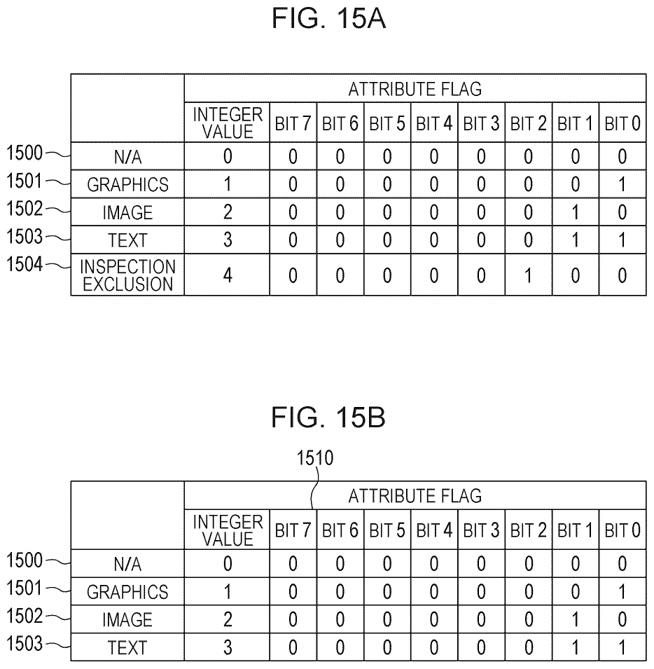

As in the example in FIG. 10A, the PDL data received by the printer 0101 in this embodiment has: vector graphics 1005 such as a line or a circle; a bitmap image or a raster image 1006; and text 1007. These data elements are drawn by using respective PDL commands and have attribute flags that are pieces of information provided on a per-pixel basis. Each attribute flag is provided to decide which image processing is to be added to the RIP image for printing in the printer 0101 after the RIP processing. In this embodiment example, the attribute flag is also referred to as pixel information. The attribute flag indicates the PDL command used to generate an image object such as a line or text. In this embodiment, there are four types of attribute flags: Graphics, Image, Text, and Inspection exclusion. Each attribute flag is expressed with an 8-bit numeric value. FIG. 15A illustrates a table of correspondence between the type of an attribute flag and an 8-bit numeric value. An integer value of 0 is assigned to N/A (1500); 1, Graphics (1501); 2, Image (1502), 3; Text (1503), and 4, Inspection exclusion (1504). The types of the attribute flags are not limited to the four types. Types other than four types may be newly generated from various print data including the PDL data and then be defined.

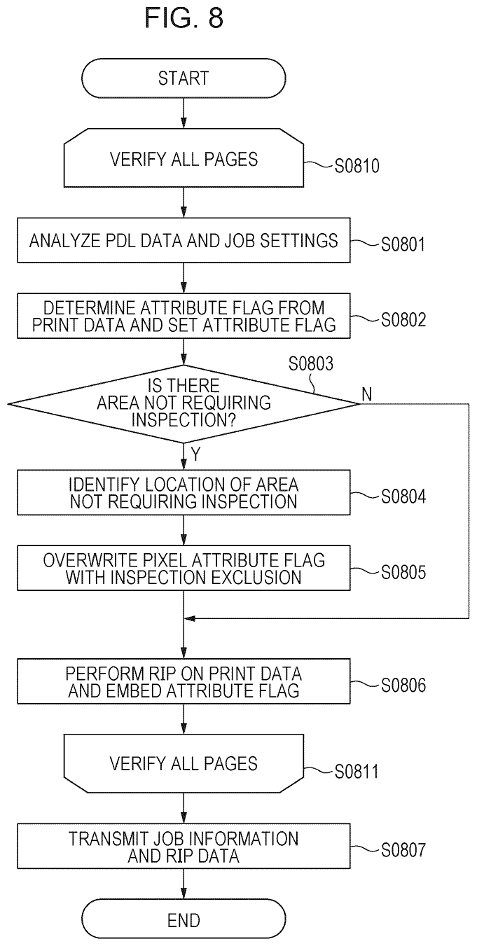

FIG. 10B illustrates part of the attribute flags (an upper left part of FIG. 10A). Each attribute flag indicates the type of a content generated in accordance with a PDL command, the type being determined on a per-pixel basis. An attribute flag determination method in this embodiment will be described later with reference to FIG. 8.

For an inspection range, the inspector 0108 defines, as an image area, a rectangular area including an image object generated in accordance with a PDL command and determines the rectangular area as an inspection area based on the attribute flag type. FIG. 10C illustrates an enlarged upper lest part of FIG. 10A. The rectangular area based on the attribute flag is decided in the following steps. The CPU 0226 extracts a separate area based on an attribute flag transmitted from the information processing apparatus 0109 (with white background in FIG. 10C). Based on the extracted area with the same attribute flag, information regarding start coordinates and end coordinates of an image object forming a line is obtained from the PDL command. FIG. 10C describes the information regarding the start coordinates and the end coordinates of each of a line as an image object 1 and a line as an image object 2. Subsequently, from the coordinates of the two image objects, the minimum value of each of the X coordinate and the Y coordinate and the maximum value of each of the X coordinate and the Y coordinate are obtained. Thereafter, a rectangular area with start coordinates (the minimum value of the X coordinate and the minimum value of the Y coordinate) and end coordinates (the maximum value of the X coordinate and the maximum value of the Y coordinate) is calculated. A rectangular area 1008 with the start coordinates (1, 1) and the end coordinates (12, 12) is obtained based on FIG. 10C (FIG. 10D).

Based on the attribute flags transmitted from the information processing apparatus 0109, the CPU 0226 obtains rectangular areas on a per attribute-flag-type basis and generates rectangular areas, starting with the initial position to the tail of a page. FIG. 10E is a view illustrating overall rectangular area images based on the attribute flag type, the images being generated from the print result image 0901 in FIG. 9A. The attribute flag N/A (0) is set in an area 1010; Graphics (1), an area 1011; Image (2), an area 1012; and Text (3), an area 1013. Each numeral in the parentheses indicates the assigned numeral. In this embodiment, the inspector 0108 obtains an inspection target area from the reference image and the attribute flag and uses the inspection target area for the inspection.

Hereinafter, processing as the features of this embodiment will bee described by using flowcharts. A program relevant to this flow of the printer 0101 is stored in the storage 0205, read out into the RAM 0202, and run by the CPU 0201. A program relevant to this flow of the inspector 0108 is stored in the storage 0228, read out into the RAM 0227, and run by the CPU 0226. A program relevant to this flow of the information processing apparatus 0109 is stored in the storage 0236, read out into the RAM 0235, and run by the CPU 0234. A program relevant to this flow of the client computer 0110 is stored in the storage 0205, read out into the RAM 0242, and run by the CPU 0243.

FIG. 8 is a flowchart of attribute flag determination by the information processing apparatus 0109. This flowchart is called when the information processing apparatus 0109 receives a print job from the client computer 0110 and performs RIP processing of the print data.

In step S0810, the CPU 0234 analyzes a print job received from the client computer 0110 on a per-page basis and performs steps S0801 to S0806 for each page. The print job is composed of at least PDL data as print data and job settings. The job settings are not necessarily required to be provided to the print job and may be received from the user via an operation unit of the information processing apparatus 0109.

In step S0801, the CPU 0234 analyzes the PDL data and the job settings of the target page. For example, if a print job in which the control bar function is on is received from the client computer 0110, the CPU 0234 analyzes the fact that the control bar function is on in step S0801.

In step S0802, the CPU 0234 determines an attribute flag from the print data and sets the attribute flag. The CPU 0234 analyzes the PDL command and sets the attribute flag in such a manner as to set, for example, Graphics in the case of drawing with vector graphics and Text in the case of drawing with a text string.

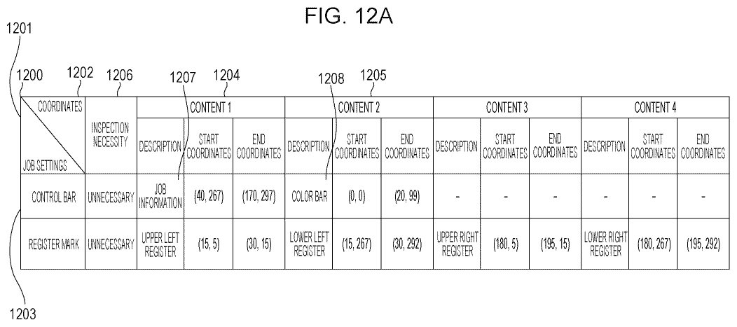

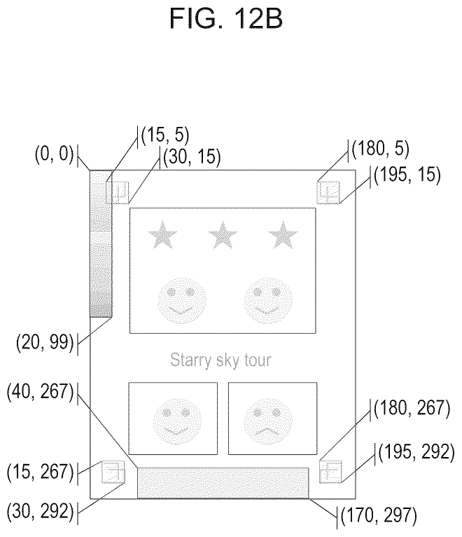

In step S0803, the CPU 0234 determines the presence or absence of an unnecessary area based on the information analyzed in step S0801. A job setting table 1200, as illustrated in FIG. 12A, in which a job setting is associated with the coordinates of a content to be drawn in accordance with the job setting is recorded in the storage 0236. Different tables are prepared for respective sheet sizes, and the job setting table 1200 is an example of a table for the sheet size A4. A Job settings row 1201 represents job settings set in a print job. Coordinates columns 1202 represent coordinates based on the upper left point as the origin (0, 0) and the lower right point as the end point (210, 297) by using a unit of mm. The location of the content is expressed by using a rectangular area with the start coordinates and the end coordinates. If one job setting covers a plurality of contents, the plurality of coordinates are recorded in the Coordinates columns 1202. For example, as illustrated in FIG. 9B, the control bar function has contents that are the job information 0911 and the color bar 0912. For the job information 0911, the coordinate information is described in Content 1 denoted by 1204. For the color bar 0912, the coordinate information is described in Content 2 denoted by 1205. FIG. 12B illustrates a view in which mapping of the coordinates recorded in the job setting table 1200 is performed on the print result image 0910. In an Inspection necessity column 1206, a content provided in accordance with the job settings is labeled with Unnecessary if the content is unnecessary. The CPU 0234 determines the presence or absence of an unnecessary area in such a manner as to search the job setting table 1200 for the information analyzed in step S0801 and verify the Inspection necessity column 1206. If there is an unnecessary area (S0803-Y), the processing proceeds to step S0804. If there is not an unnecessary area (S0803-N), the processing proceeds to step S0806.

In step S0804, the CPU 0234 identifies the location of the unnecessary area. The CPU 0234 identifies the location of the unnecessary area in such a manner as to search the job setting table 1200 for the information analyzed in step S0801 and refer to the Coordinates columns 1202. In this embodiment example, a rectangular area with the start coordinates and the end coordinates is handled as an unnecessary area. As a method for calculating a rectangular area, the method based on the start coordinates and the end coordinates that is described with reference to FIG. 10C is used.

In step S0805, the CPU 0234 overwrites the attribute flag of the unnecessary area identified in step S0804 with Inspection exclusion. In this embodiment example, the description is provided on the assumption that a rectangularly defined area is handled as an unnecessary area and Inspection exclusion is set as the attribute flag; however, the steps are not limited to these. Inspection exclusion may be set as the attribute flag for an area before the rectangular area is defined, and the inspector may define the rectangular area in step S1306 (described later).

In step S0806, the CPU 0234 performs RIP of the print data and embeds the attribute flags set in steps S0802 and S0805 in the RIP data. FIG. 10F illustrates overall rectangular area images based on the type of the attribute flag, the images being generated from the print result image 0910 in FIG. 9B. As compared with FIG. 10E, attribute flags 1014 and 1015 overwritten with Inspection exclusion in step S0805 are added.

In step S0807, the CPU 0234 transmits the job information and the RIP data to the printer 0101 and the inspector 0108.

FIG. 6 is a flowchart of reference image registration by the inspector 0108. This flowchart is called when the reference image registration is performed.

In step S0601, the CPU 0226 receives an instruction to start image reading from the user via the inspection button 0502 on the display device 0245. The processing then proceeds to step S0602 and repeats steps until the reference images of all of the sheets are stored.

In step S0603, the inspection unit I/F 0231 receives, from the inspector I/F 0215, a reference image scanned with the CIS 0315 and the CIS 0316 if the inspection method is Scan inspection. If the inspection method is RIP inspection, the inspection unit I/F 0231 receives, from the inspector I/F 0215, a reference image generated before the printer 0101 performs printing. This reference image includes the information regarding the attribute flag embedded by the information processing apparatus 0109 in step S0806. In the case of Scan inspection, the reference image does not include the information regarding the attribute flag.

In step S0604, the CPU 0226 registers the image received in step S0603 as the reference image in the RAM 0227. The inspection method is the method selected in the inspection method selection field 0404 in FIG. 4A previously mentioned.

The processing proceeds to step S0605 and repeats steps S0602 to S0605 until the image reading of all of the sheets is completed. If the image reading of all of the sheets is completed, the processing proceeds to step S0606, and the CPU 0226 receives an instruction to terminate image reading from the user through the display device 0245.

The example described herein is an example, for example, the instruction to start image reading from the user on the display device 0245 may be given automatically in conjunction with a print start instruction in the printer 0101, the information processing apparatus 0109, and the client computer 0110. The instruction to terminate image reading from the user on the display device 0245 may also be given automatically in conjunction with the printing end in the printer 0101, and the form thereof is not limited.

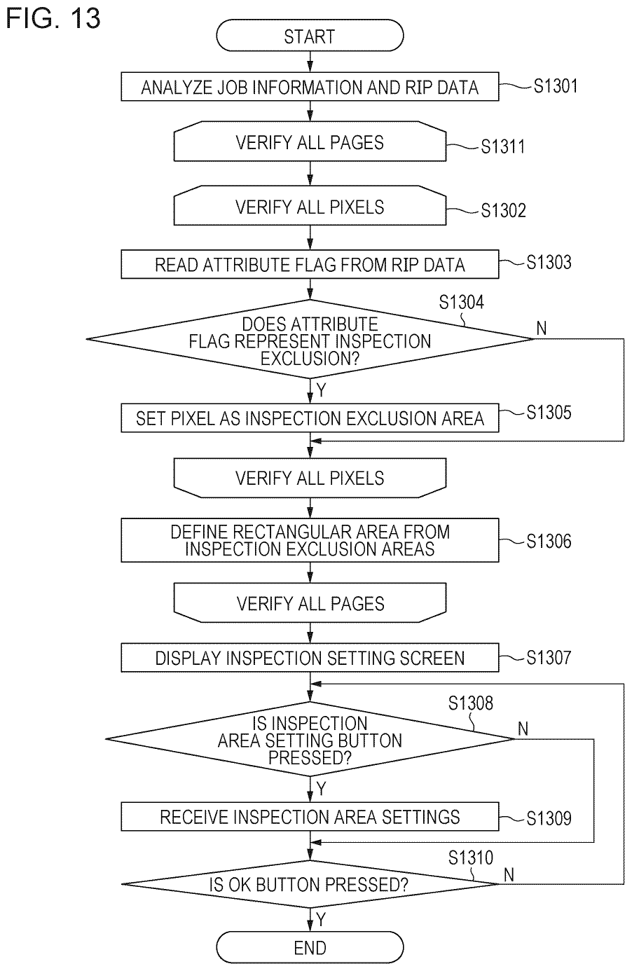

FIG. 13 is a flowchart of inspection area settings in the inspector 0108. This flowchart is called after the end of the flowchart of the reference image registration in FIG. 6.

In step S1301, the CPU 0226 analyzes the job information received from the information processing apparatus 0109 and the RIP data.

In step S1311, the CPU 0226 performs steps S1302 to S1306 on all of the pages of the RIP data received from the information processing apparatus 0109.

In step S1302, the CPU 0226 performs steps S1303 to S1305 on every pixel in the target page.

In step S1303, the CPU 0226 reads an attribute flag of the object pixel from the analyzed RIP data.

If the attribute flag of the object pixel is Inspection exclusion (S1304-Y) in step S1304, the CPU 0226 proceeds to step S1305. If not (S1304-N), the CPU 0226 skips step S1305.

In step S1305, the CPU 0226 records the object pixel as the inspection exclusion area.

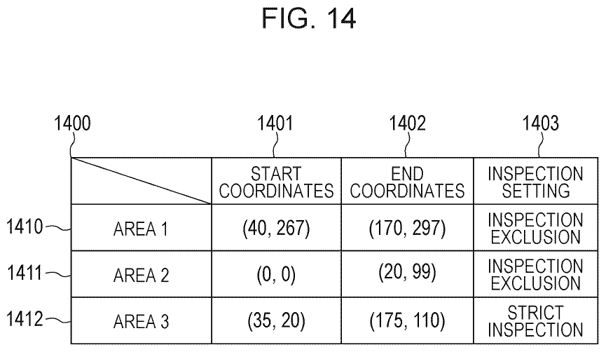

In step S1306, the CPU 0226 defines a rectangular area based on the inspection exclusion areas recorded on a per-pixel basis in steps S1303 to S1305. As a method for calculating a rectangular area, the method based on the start coordinates and the end coordinates that is described with reference to FIG. 10C is used. Coordinates after the rectangular area definition are recorded as Start coordinates 1401 and End coordinates 1402 in an inspection setting table 1400 illustrated in FIG. 14. The inspection setting table 1400 is generated on a per-page basis. Inspection settings of rectangular areas each expressed by using the Start coordinates 1401 and the End coordinates 1402 are recorded in an Inspection setting column 1403. FIG. 14 illustrates an example of the inspection setting table 1400 in a case where Inspection exclusion is set as the attribute flag based on information in a Control bar row 1203 in the job setting table 1200. Area 1 denoted by 1410 is an inspection exclusion area corresponding to Job information 1207 in the job setting table 1200. Area 2 denoted by 1411 is an inspection exclusion area corresponding to Color bar 1208 in the job setting table 1200. If the information processing apparatus 0109 has performed, on the page, the rectangular area definition in step S0804, the rectangular area definition in step S1306 is omitted.

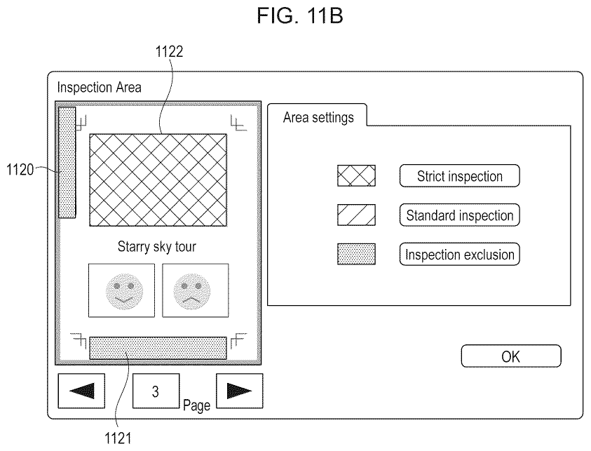

In step S1307, the CPU 0226 displays an inspection setting screen on the display device 0245. FIG. 11A illustrates an example of the inspection setting screen. An inspection setting screen 1100 includes an inspection area 1101 and inspection area settings 1102. An inspection area image 1105 displays a reference image and an inspection area. Reference numeral 1108 denotes the number of pages of the displayed print data. In response to one of arrow buttons 1107 and 1109 being pressed, the display device 0245 displays the reference image and the inspection area of the next page according the arrow button. Buttons 1110 to 1112 for setting inspection areas are displayed in the inspection area settings 1102. Processing to be performed in response to one of the buttons being pressed will be described later with reference to step S1308 and step S1309.

In step S1308, the CPU 0226 determines whether one of the inspection area settings buttons 1110 to 1112 is pressed. If one of the buttons is pressed (S1308-Y), the processing proceeds to step S1309. If not (S1309-N), the processing proceeds to step S1310.

In step S1309, the CPU 0226 receives the inspection area settings. A Strict inspection button 1110 is a button used when an area to be inspected more strictly is set. A Standard inspection button 1111 is a button used when an area to be inspected with a normal level is set. An Inspection exclusion button 1112 is a button used when an area to be excluded from the inspection is set. In response to one of the buttons 1110 to 1112 being pressed, a rectangle in a pattern displayed on the left side of the button is displayed in the inspection area image 1105. Scaling and moving the rectangle enable an inspection area to be set. The set rectangle is recorded in the inspection setting table 1400 by using coordinates. Area 3 denoted by 1412 in the inspection setting table 1400 is an example of an area set based on the Strict inspection button 1110. FIG. 11B illustrates a screen on which inspection area settings in the inspection setting table 1400 are superimposed on the reference image. Area 1 denoted by 1410 is expressed as a rectangular area 1121. Area 2 denoted by 1411 is expressed as a rectangular area 1120. Area 3 denoted by 1412 is expressed as a rectangular area 1122. FIG. 11B illustrates the strict inspection area and the inspection exclusion area that are filled; however, the area display method is not limited to this. The inspection areas may be displayed with frames or may be filled translucently.

In step S1310, the CPU 0226 determines whether an OK button 1103 is pressed. If the OK button 1103 is pressed (S1310-Y), this flowchart is terminated, and the processing proceeds to the screen for running the inspection application illustrated in FIG. 5. If not (S1310-N), the processing returns to step S1308.

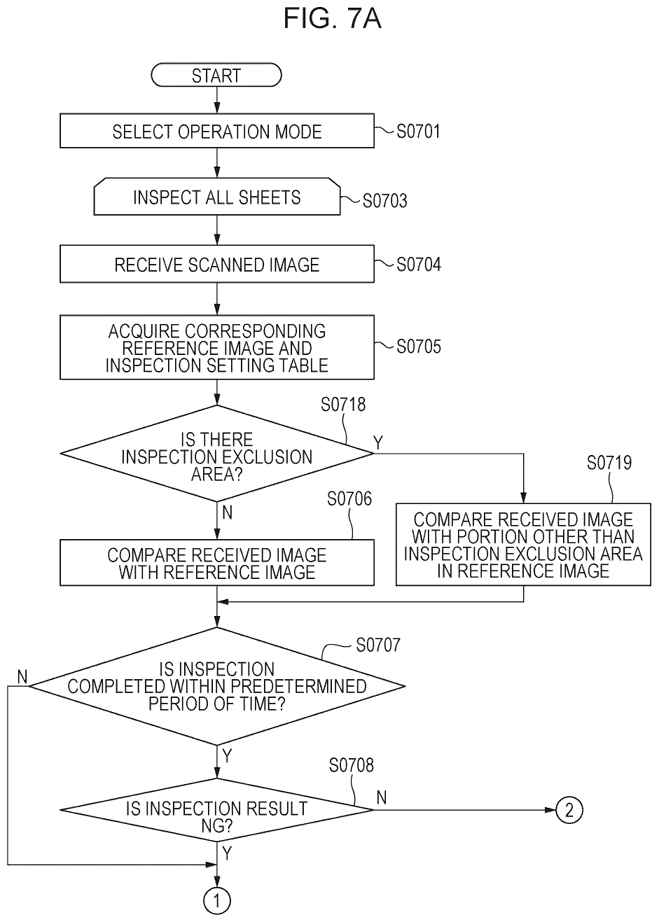

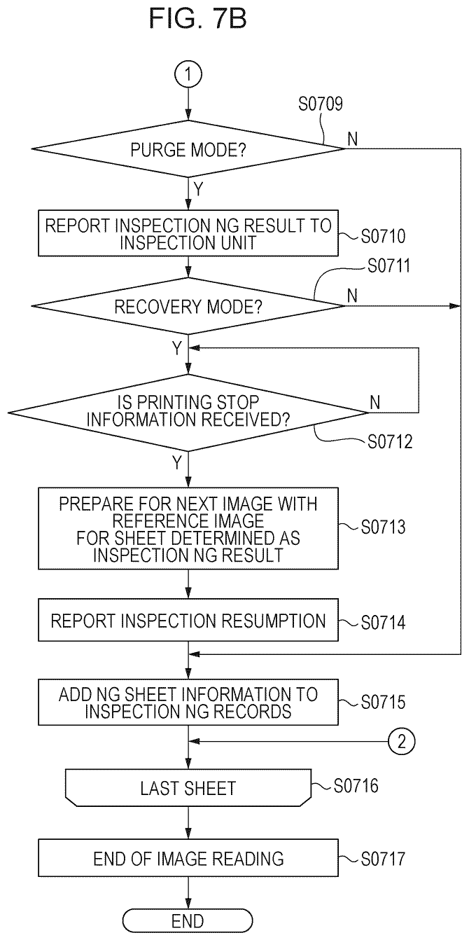

FIGS. 7A and 7B are flowcharts of an inspection by the inspector 0108. This flowchart is called after the end of the flowchart of the inspection area settings in FIG. 13.

In step S0701, the CPU 0226 receives an operation mode and a recovery mode setting respectively in the operation mode selection field 0402 and on the recovery mode setting screen 0403. The CPU 0226 receives an inspection method setting in the inspection method selection field 0404. The processing then proceeds to step S0703. If there is an inspection target sheet, the processing proceeds to step S0704.

In step S0704, the inspection unit I/F 0231 receives an image scanned with the CIS 0315 and the CIS 0316 from the inspector I/F 0215. The image results from the scanning of the print job print result to serve as a merged document, and the inspector 0108 performs the inspection in such a manner as to compare the scanned image with the reference image decided in the flowchart in FIG. 6.

In step S0705, the CPU 0226 reads out, from the RAM 0227, the reference image registered in step S0604 and information regarding a page that corresponds to the scanned image received in step S0704 (hereinafter, referred to as a target page) and that is included in the inspection setting tables 1400 generated in step S1306.

In step S0718, the CPU 0226 refers to the Inspection setting column 1403 in the inspection setting table 1400 and determines whether there is an inspection exclusion area in the target page. If there is the inspection exclusion area (S0718-Y), the processing proceeds to step S0719. If not (S0718-N), the processing proceeds to step S0706.

In step S0706, the CPU 0226 compares the reference image read out in step S0705 with the scanned image of the inspection target received in step S0704. In the comparison operation, the image positions of the reference image and the scanned image of the inspection target are first matched by using a feature point of the image as the reference point for alignment. The CPU 0226 then analyzes the four corners of the sheet and the alignment reference point of the scanned image in the scanned image of the inspection target to detect whether there is a positional shift in the image with respect to the sheet. The CPU 0226 then makes comparison of a density value between the reference image and the scanned image of the inspection target on a per-pixel basis.

In step S0719, the CPU 0226 compares the reference image read out in step S0705 with the scanned image of the inspection target received in step S0704 in consideration of the inspection exclusion area. For an area associated with Inspection exclusion in the Inspection setting column 1403 in the inspection setting table 1400, the area is determined to have no difference without verifying the difference between the scanned image and the reference image. For the other areas, the reference image is compared with the scanned image of the inspection target in the same manner as in step S0706.

If a difference is not detected between the scanned image and the reference image as the result of this, the inspection result is determined as OK. If a difference is detected, the inspection result is determined as NG, and the details of the inspection NG result described with reference to FIG. 5 are recorded according to the defect type.

Subsequently, if the inspection is completed within a predetermined period of time in step S0707, the processing proceeds to step S0708. If the inspection is not completed within the predetermined period of time, the processing proceeds to step S0709. The determination is performed for the following reasons. Unless the inspection is completed within the predetermined period of time to provide an inspection result, the inspection unit I/F 0231 and the inspector I/F 0215 fail to start handling of a scanned image of a succeeding sheet scanned with the CISs 0315 and 0316 in time. In addition, if Purge mode is selected in the operation mode selection field 0402, the CPU 0221 switches the transportation destination to discharge, to the top tray 0320, a sheet determined as the inspection NG result by the inspector 0108 discharge. The CPU 0226 needs to report the inspection NG result to the CPU 0221 via the inspection unit I/F 0231, the inspector I/F 0215, the accessory I/F 0214, and the accessory I/F 0220 before the sheet reaches a point where the switching of the transportation destination is not allowed.

Accordingly, if the inspection is not completed within the predetermined period of time, it is not possible to determine the inspection result as OK. The CPU 0226 thus regards the inspection result as an inspection result error and determines the sheet inspection result as a result equivalent to the inspection NG result.

If the inspection result is NG in step S0708, the processing proceeds to step S0709. In step S0709, the CPU 0226 reads out the operation mode from the RAM 0227. If the operation mode is Purge mode, the processing proceeds to step S0710. In step S0710, the CPU 0226 reports the inspection NG result to the CPU 0216 via the inspection unit I/F 0231 and the inspector I/F 0215.

The processing then proceeds to step S0711. If the recovery mode read out from the RAM 0227 by the CPU 0226 is Recovery mode, the processing proceeds to step S0712. In step S0712, the CPU 0226 waits until the CPU 0226 receives the printing stop information from the CPU 0216 via the inspection unit I/F 0231 and the inspector I/F 0215. If the CPU 0226 receives the printing stop information, the processing proceeds to step S0713.

In step S0713, the CPU 0226 reads out, from the RAM 0227, a reference image corresponding to the sheet having the inspection NG result and holds the reference image as an image for the next inspection. The processing then proceeds to step S0714, and the CPU 0226 reports the resumption of the inspection to the CPU 0216 via the inspection unit I/F 0231 and the inspector I/F 0215.

The processing then proceeds to step S0715, and the CPU 0226 adds information regarding the sheet having the inspection NG result to the inspection NG list 0504.

The processing then proceeds to step S0716 and repeats steps S0703 to S0716 until the inspection of all of the sheets are completed. If the inspection of all of the sheets is completed, the processing proceeds to step S0717, and the CPU 0226 receives an instruction from the user to terminate image reading on the display device 0245 via the inspection button 0502.

If the recovery mode read out from the RAM 0227 by the CPU 0226 is Non-recovery mode in step S0711, the processing proceeds to step S0715 and may be terminated in the succeeding steps in the same manner as in the flow described above. If the operation mode is Log mode in step S0709, the processing proceeds to step S0715 and may be terminated in the succeeding steps in the same manner as in the flow described above.

Further, if the inspection result is OK in step S0708, the processing proceeds to step S0716 and may be terminated in the succeeding steps in the same manner as in the flow described above.

As described above, in the first embodiment, Inspection exclusion is used as the attribute flag in the RIP data. This enables an inspection exclusion area to be set automatically in the inspector 0108.

### Second Embodiment

In the first embodiment, how to set an inspection exclusion area on a per-page basis has been described. In a case where paper is cut with an off-line finisher or the like, marks such as a control bar and register marks are printed only on the start page on occasions. If the first embodiment is applied to this case, areas where the control bar and the register marks are printed become inspection targets in pages succeeding the start page. For this reason, although dirt in a cutting area does not cause trouble with a printing result, the presence of the dirt in the cutting area results in inspection NG. In a second embodiment, how to set an inspection exclusion area automatically in pages succeeding the start page despite the presence of an inspection exclusion area only in the start page will be described.

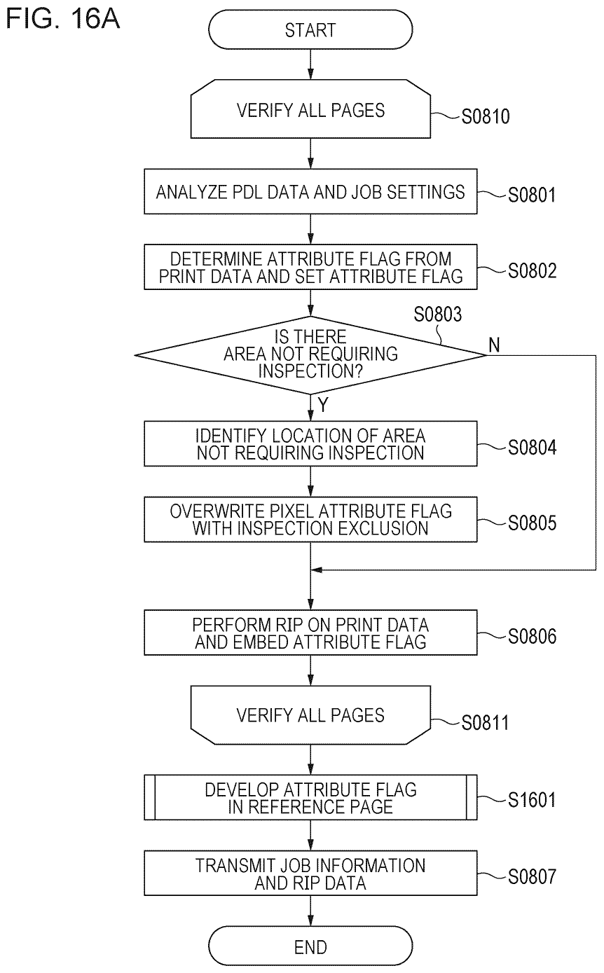

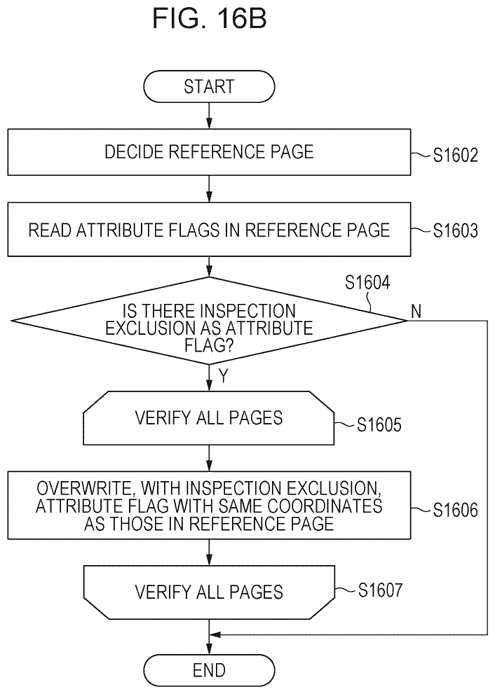

FIG. 16A is a flowchart of attribute flag determination by the information processing apparatus 0109. This flowchart is called when the information processing apparatus 0109 receives a print job from the client computer 0110 and the information processing apparatus 0109 performs RIP of the print data. Description of steps S0801 to S0811 that are the same as those in the first embodiment is omitted.

After the attribute flag of all of the pages are set, the CPU 0234 performs processing for developing an attribute flag in the reference page in one or more different pages in step S1601. Specific processing details will be described with reference to the flowchart in FIG. 16B.

FIG. 16B is a flowchart of the processing for developing an attribute flag in the reference page in one or more different pages, the processing being performed by the information processing apparatus 0109.

In step S1602, the CPU 0234 decides a reference page in the print job. The reference page is a page serving as a base for developing an inspection exclusion area in one or more different pages. The reference page is decided in such a manner as to be selected by the user or selected automatically depending on the orientation or the order of discharging (for example, a start page in face-up reverse discharging).

In step S1603, the CPU 0234 reads the attribute flags embedded in step S0806 in the reference page.

In step S1603, the CPU 0234 determines whether there is Inspection exclusion as the attribute flag in the reference page. If there is Inspection exclusion as the attribute flag (S1604-Y), the processing proceeds to step S1605. If not (S1604-N), this flowchart is terminated.

In step S1605, the CPU 0234 performs step S1606 for each page.

In step S1606, the CPU 0234 overwrites, with Inspection exclusion, the attribute flag with the same coordinates in the target page as the coordinates for Inspection exclusion as the attribute flag in the reference page.

As described above, in the second embodiment, the area assigned Inspection exclusion in the reference page is developed in one or more different pages. The inspection exclusion area may thereby automatically set in a page other than the reference page.

### Third Embodiment

In the first embodiment, how to overwrite the already set attribute flag (S0802) with Inspection exclusion (S0805) after the information processing apparatus 0109 determines an unnecessary area. However, the overwriting the attribute flag in the first embodiment prevents image processing appropriate for the attribute flag from being applied in the printer 0101. In a third embodiment, how to achieve both of the attribute flag set in step S0802 and the attribute flag of Inspection exclusion will be described.

FIG. 15B illustrates a table of correspondence between the type of an attribute flag in this embodiment example and an 8-bit numeric value. N/A (1500), Graphics (1501), Image (1502), and Text (1503) are the same as those in the first embodiment. In this embodiment example, Inspection exclusion is not defined as the integer value, and bit 7 (1510) is handled as a bit dedicated to Inspection exclusion. If bit 7 is 1, Inspection exclusion is assigned the pixel. That is, Graphics and Inspection exclusion can be expressed by an integer value of 129 (10000001 in the bit notation), and an object pixel assigned Image and Inspection exclusion can be expressed by an integer value of 130 (10000010 in the bit notation).

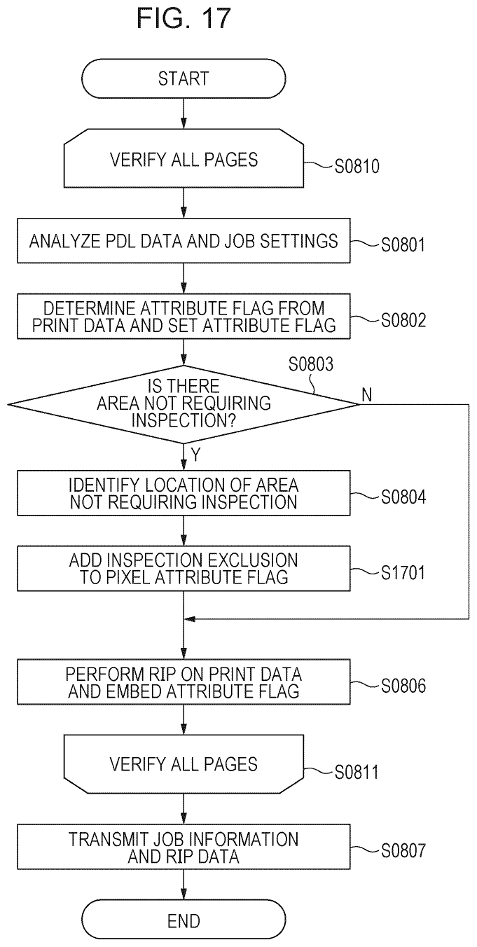

FIG. 17 is a flowchart of attribute flag determination by the information processing apparatus 0109. This flowchart is called when the information processing apparatus 0109 receives a print job from the client computer 0110 and the information processing apparatus 0109 performs RIP of the print data. Description of steps S0801 to S0811 that are the same as those in the first embodiment is omitted.

In step S1701, the CPU 0234 adds Inspection exclusion to the attribute flag of the object pixel. For example, if a pixel is determined as Graphics in step S0802 and having an integer value of 1 (00000001 in the bit notation) set therefor is also in an inspection exclusion area, 1 is set as bit 7 to be assigned an integer value of 129 (10000001 in the bit notation). FIG. 10G illustrates overall rectangular area images based on the attribute flag type, the images being generated from the print result image 0910 in FIG. 9B. As compared with FIG. 10F, an area (1016) with an integer value of 129 is added due to the attribute flag of Inspection exclusion added in step S1701. The area (1016) with the integer value of 129 is processed as a graphic area in the image processing and is set as Inspection exclusion in the inspection setting operation. That is, in the inspection setting operation, priority is given to an attribute flag indicating Inspection exclusion.

As described above, in the third embodiment, both of the attribute flag set in step S0802 and the attribute flag of Inspection exclusion are achieved. Image processing appropriate for the attribute flag may thereby be applied in the printer 0101.

### Fourth Embodiment

In the first to third embodiments, how to set Inspection exclusion as the attribute flag by the information processing apparatus 0109 has been described. However, in the first to third embodiments, it is not possible to automatically set an inspection exclusion area if an image or the like provided by the printer 0101 has an inspection exclusion area. In a fourth embodiment, setting of Inspection exclusion as the attribute flag by the printer 0101 is described. The handling of the attribute flag of the first embodiment (FIG. 15A) is used in the description; however, the handling of the attribute flag of the third embodiment (FIG. 15B) is also applicable.

FIG. 9C represents a print result image 0920 at the time when the front/back side registration adjustment function of the printer 0101 is on. If the front/back side registration adjustment function is on, the CPU 0201 provides print data with patches (marks) 0921 to 0924 for adjusting front/back side registration positions at predefined positions. The printer 0101 knows a positional shift between images printed on the sheet in such a manner as to read the patches 0921 to 0924 with an internal sensor and performs adjustment to match the positions of the respective images on the front side and the back side of the sheet.

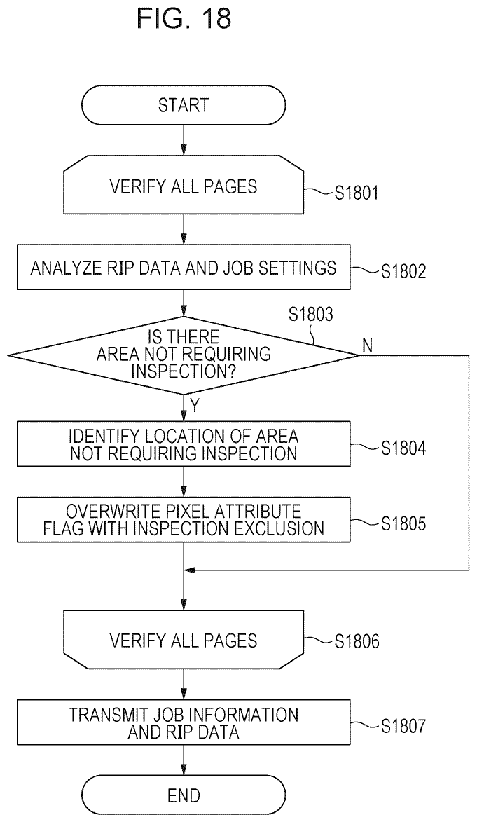

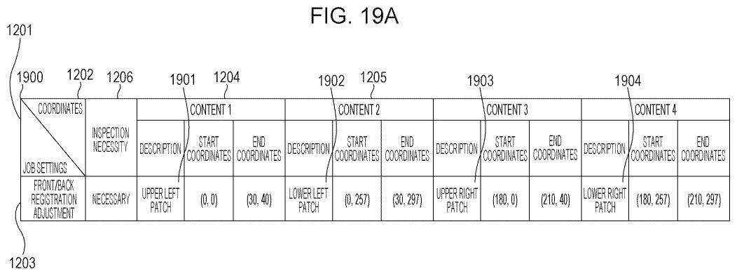

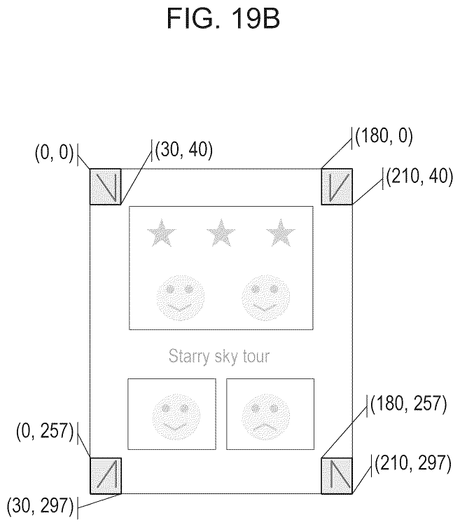

FIG. 18 is a flowchart of attribute flag determination by the printer 0101. This flowchart is called when the printer 0101 receives job information and RIP data from the information processing apparatus 0109 and performs job processing.

In step S1801, the CPU 0201 analyzes the print job received from the information processing apparatus 0109 on a per-page basis and performs steps S1802 to S1805 for each page.

In step S1802, analyzes the RIP data and the job settings of the target page. For example, a print job with the front/back side registration adjustment function being on is received from the information processing apparatus 0109, the CPU 0201 analyzes the front/back side registration adjustment function in step S1802.

In step S1803, the CPU 0201 determines the presence or absence of an unnecessary area based on the information analyzed in step S1802. A job setting table 1900, as illustrated in FIG. 19A, in which a job setting is associated with the coordinates of a content to be drawn in accordance with the job setting is recorded in the storage 0236. Different tables are prepared for respective sheet sizes, and the job setting table 1900 is an example of a table for the sheet size A4. Items 1201 to 1206 are the same as those in the job setting table 1200, and thus description thereof is omitted. For example, in the front/back side registration adjustment function, as illustrated in FIG. 9C, the patches 0921 to 0924 are provided. Coordinate information of the patches 0921 to 0924 is described in fields 1901 to 1904. FIG. 19B illustrates view in which mapping of the coordinates recorded in the job setting table 1900 is performed on the print result image 0920. The CPU 0201 determines the presence or absence of an unnecessary area in such a manner as to search the job setting table 1900 for the information analyzed in step S1802 and verify the Inspection necessity column 1206. If there is an unnecessary area (S1803-Y), the processing proceeds to step S1804. If there is not an unnecessary area (S1803-N), the processing proceeds to step S1806.

In step S1804, the CPU 0201 identifies the location of the unnecessary area. The CPU 0201 identifies the location of the unnecessary area in such a manner as to search the job setting table 1900 for the information analyzed in step S1802 and refer to the Coordinates columns 1202. In this embodiment example, a rectangular area with the start coordinates and the end coordinates is handled as an unnecessary area. As a method for calculating a rectangular area, the method based on the start coordinates and the end coordinates that is described with reference to FIG. 10C is used.

In step S1805, the CPU 0201 overwrites the attribute flag of the unnecessary area identified in step S1804 with Inspection exclusion.

In step S1807, the CPU 0201 transmits the job information and the RIP data to the inspector 0108.

As described above, in the fourth embodiment, the printer 0101 sets Inspection exclusion as the attribute flag. The inspection exclusion area may thereby be automatically set even if the image or the like provided by the printer 0101 has an inspection exclusion area.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™M), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-160114, filed Sep. 25, 2023, which is hereby incorporated by reference herein in its entirety.

What is claimed is:

1. An information processing apparatus connectable to at least a printer and an inspector that performs inspection of a printed material printed with the printer, the information processing apparatus comprising:
a reception unit that receives a job setting for received print data;
a generation unit that generates image data in which pixel information is added to the print data; and
a transmitter unit that transmits the image data,
wherein in response to the reception unit receiving a predetermined job setting, the generation unit assigns pixel information indicating exclusion from the inspection by the inspector to a pixel in an image area provided in the job setting.

2. The information processing apparatus according to claim 1,
wherein the generation unit provides the pixel information by analyzing a PDL command for the print data.

3. The information processing apparatus according to claim 1,
wherein the generation unit generates the image data by embedding the pixel information in an RIP image generated by performing RIP processing on the print data.

4. The information processing apparatus according to claim 1,
wherein the job setting is a setting to provide the print data with a predetermined image.

5. The information processing apparatus according to claim 4, further comprising:
a storage unit that stores the job setting and information regarding an area in which the predetermined image is to be provided, the job setting and the information being stored in association with each other.

6. The information processing apparatus according to claim 4,
wherein the predetermined image is a control bar.

7. The information processing apparatus according to claim 4,
wherein the predetermined image is a register mark.

8. The information processing apparatus according to claim 4,
wherein the predetermined image is a patch for a front/back side registration adjustment function.

9. The information processing apparatus according to claim 1, further comprising:
a receiver unit that receives a print job including the print data and the job setting,
wherein the reception unit receives the job setting included in the print job.

10. The information processing apparatus according to claim 1,
wherein the reception unit has an operation unit, and
wherein the reception unit receives the job setting through operation of the operation unit.

11. An inspector which performs inspection of a printed material printed with a printer, the inspector comprising:
a first receiver unit that receives image data having pixel information;
a registration unit that registers the image data as a reference image;
a second receiver unit that receives a scanned image acquired by scanning the printed material printed with the printer;
a setting unit that sets at least an inspection exclusion area to be excluded from the inspection, the inspection exclusion area being set in the reference image based on the pixel information; and
an inspection unit that performs the inspection of the printed material based on the reference image and the scanned image,
wherein the inspection unit does not perform the inspection in the inspection exclusion area set by the setting unit.

12. The inspector according to claim 11, further comprising:
a display unit that displays a screen,
wherein the display unit displays a screen on which the inspection exclusion area set by the setting unit is superimposed on the reference image.

13. The inspector according to claim 11,
wherein the pixel information is information indicating attribute information per pixel, and
wherein an image acquired from the image data is a RIP image in which the attribute information is embedded.

14. The inspector according to claim 11,
wherein in response to graphics information and information leading to exclusion from the inspection being assigned, as the pixel information, to a predetermined pixel, the predetermined pixel undergoes image processing for graphics and does not undergo the inspection.

15. An inspection system which performs inspection of a printed material, the inspection system comprising:
a reading unit that reads the printed material and generates a read image;
a registration unit that registers print data as a reference image;
a display unit that displays a setting screen on which an inspection setting is allowed, the inspection setting including an inspection area to undergo the inspection and an inspection exclusion area to be excluded from the inspection; and
an inspection unit that performs inspection of the read image based on the reference image and the inspection setting,
wherein the display unit displays a setting screen on which at least the inspection exclusion area is set in advance based on information included in the reference image, the setting screen being displayed in a state without the inspection setting.

16. The inspection system according to claim 15,
wherein the information included in the reference image is information provided by analyzing a PDL command for the print data.

17. The inspection system according to claim 15,
wherein the information included in the reference image is information provided to an RIP image generated by performing RIP processing on the print data.
